(19) United States
(12) Patent Application Publication
(10) Pub. No.: US 2026/0103335 A1
(43) Pub. Date: Apr. 16, 2026

(54) Modular Wide Top Beam Extension System

(71) Applicants: Prime Design Engineering Ltd, Bridgend (GB); Doleco USA, Inc., Meriden, CT (US)

(72) Inventor: Richard Jones, Bridgend (GB)

(73) Assignees: Prime Design Engineering Ltd, Bridgend, WL (GB); Doleco USA, Inc., Meriden, CT (US)

(21) Appl. No.: 19/354,926

(22) Filed: Oct. 10, 2025

Related U.S. Application Data
(60) Provisional application No. 63/706,728, filed on Oct. 13, 2024.

(51) Int. Cl. B65D 90/00; B65D 88/12

(52) U.S. Cl. CPC B65D 90/004; B65D 88/121

(57) ABSTRACT

A modular wide top beam extension system for cargo containers is disclosed. The system comprises a base beam with a rectangular cross-section and a removable modular top section. The base beam includes notches on its side walls, while the modular top section features a flat top surface extending beyond the base beam's width and vertically descending sections with clips. These clips engage with the notches, securing the top section to the base beam. This design allows for easy installation, removal, and replacement of the wide top section. The system can be manufactured from various materials, including metals, plastics, and composites, to suit different load requirements. The modular nature of the system reduces costs by allowing the base beam to function independently or as part of a wide-top configuration.

### TECHNICAL FIELD

The present disclosure generally relates to the field of cargo control and more specifically to a system of adjustable load beams that provide decking to divide the cargo container into multiple levels of payload.

### BACKGROUND

In freight transportation, maximizing the utilization of available space within cargo containers is crucial for operational efficiency and cost-effectiveness. To achieve this, it is common practice to stack cargo in multiple levels, taking full advantage of the vertical space in cargo containers such as truck trailers, aircraft cargo holds, railroad cars, and other similar cargo enclosures. This multi-level stacking approach necessitates the use of robust and versatile decking systems.

At the heart of these decking systems are removable decking beams, designed to support substantial payload weights while offering flexibility in cargo arrangement. These beams are typically adjustable, allowing for repositioning at various heights and horizontal intervals within the cargo container. This adaptability is essential to accommodate the diverse sizes and shapes of cargo items transported across different industries.

A conventional cargo beam and decking system, as illustrated in FIG. 1, comprises several key components. The system includes a series of vertical mounting tracks 10 that line the walls along the length of the cargo container. These tracks feature a sequence of openings or slots, enabling the adjustment of decking beam heights to suit specific cargo requirements. In a typical configuration, multiple decking beams 20 span the width of the container, creating supportive platforms for upper layers of cargo pallets 30.

The adjustable decking beam itself, depicted in FIG. 2, consists of several parts working in concert. The beam 40 comprises a central hollow section 50, flanked by two adjustable end pieces 60, 70 that can slide within the beam's ends. Each of these end pieces terminates in a “foot” 65, 75 designed to engage with the vertical mounting tracks on the container walls. These feet incorporate trigger-operated locking mechanisms 80 that interface with the openings in the mounting tracks, allowing for secure positioning of the beams at desired heights.

FIG. 3 provides a more detailed view of a typical decking beam's structure. The beam 10 (identified in FIG. 3) extends along a longitudinal axis between its first and second end, with both external and internal surfaces. A channel 6 runs the length of the beam between these ends. In cross-section, the beam presents a rectangular profile perpendicular to its longitudinal axis. This profile is formed by parallel top 4 and bottom walls intersecting with parallel left 2 and right side walls at right angles, creating the rectangular channel that runs through the beam's length.

The top wall's exterior surface 4 serves as the primary support surface for cargo loads. During normal operation, this surface is typically oriented parallel to the ground, providing a stable platform for cargo. Some beam designs incorporate additional features on this top surface, such as grooves 8 running along the beam's axis, which serve to enhance friction and improve load stability.

However, traditional decking beam designs face several challenges in practical application. One significant issue is the susceptibility of beams to damage, particularly denting or bending, during the often-rigorous processes of cargo loading and unloading. Another common problem is that the width of the beam's top surface may not provide sufficient friction or load distribution for certain types of cargo, potentially leading to instability or damage to goods.

To address these issues, some manufacturers have developed beams with wider top surfaces relative to their bottom widths, as shown in FIGS. 4A-4C. These designs aim to increase the contact area between the beam and the cargo, thereby improving load distribution and reducing the risk of damage to both the beam and the cargo. In each of these embodiments, the expanded top section is integrated into the extrusion that forms the beam. The expanded top surface also provides additional structural strength, offering better resistance to side impacts during loading operations. These wide-top beams often feature a T-shaped profile.

While these wide-top designs offer improvements over standard rectangular beams, they introduce new challenges. A significant drawback is that damage to the top surface—a common occurrence in the demanding environment of freight handling—often necessitates the replacement of the entire beam. This can lead to increased maintenance costs and operational downtime.

Given these persistent challenges, there remains a clear need in the industry for an improved decking beam system. Such a system should ideally combine the structural advantages of wide-top beams with enhanced durability, easier maintenance, and greater adaptability to varied cargo requirements. The present invention addresses these needs, offering a novel solution that promises to advance the state of the art in cargo container decking systems.

### SUMMARY OF THE INVENTION

The needs set forth herein as well as further and other needs and advantages are addressed by the present teachings, which illustrate solutions and advantages described below.

The present invention addresses the longstanding need in the cargo transportation industry for an improved decking beam system. This novel modular wide top beam extension system offers a versatile solution to the limitations of traditional decking beams, particularly addressing issues of damage susceptibility and insufficient load distribution.

At its core, the invention comprises a modular top section designed to be securely fastened to an existing beam profile. This innovative approach allows for the expansion of a standard beam into a wider top beam, significantly enhancing its structural capabilities and load-bearing surface area. The system's modular nature provides unprecedented flexibility, allowing users to adapt their equipment to varying cargo requirements without the need for complete beam replacement. It also allows for easy and cost effective replacement of damaged parts.

A key feature of the invention is its ease of replacement and maintenance. The modular top section can be easily detached and replaced if damaged, minimizing downtime and reducing repair costs. This represents a significant improvement over traditional wide-top beams, where damage often necessitates the replacement of the entire beam.

The system's design accommodates various manufacturing materials, including metals, plastics, and composites. This material flexibility allows for customization to meet specific application requirements, from lightweight to heavy-duty use cases. Furthermore, the modular construction can be implemented as a single piece covering the full beam length, as separate sections for each side, or as multiple interlocking or bonded sections, providing adaptability to diverse cargo scenarios.

An additional benefit of this system is the reduction in inventory costs for users. The underlying beam can function independently as a standard beam, while the modular top section serves as an economical accessory to create a wide-top beam when needed. This dual functionality significantly reduces the need to stock multiple types of complete beam assemblies.

These and other aspects of the present invention will become apparent in light of the drawings and detailed description provided below.

### BRIEF DESCRIPTION OF THE DRAWINGS

FIG. 1 illustrates a cut-away perspective view of a truck trailer employing a cargo beam and decking system.

FIG. 2 is side view of an adjustable decking beam.

FIG. 3 is a perspective view of a beam of a decking beam.

FIG. 4A illustrates a cross section of a decking beam.

FIG. 4B illustrates a cross section of a decking beam.

FIG. 4C illustrates a cross section of a decking beam.

FIG. 5 illustrates a cross section view of a wide top beam extension system in accordance with one embodiment of the present invention.

FIG. 6 illustrates a perspective view of a wide top beam extension system in accordance with one embodiment of the present invention.

FIG. 7 illustrates a cross section view of a wide top beam extension system in accordance with one embodiment of the present invention.

FIG. 8 illustrates a system in accordance with one embodiment of the present invention.

FIG. 9 illustrates a system in accordance with one embodiment of the present invention.

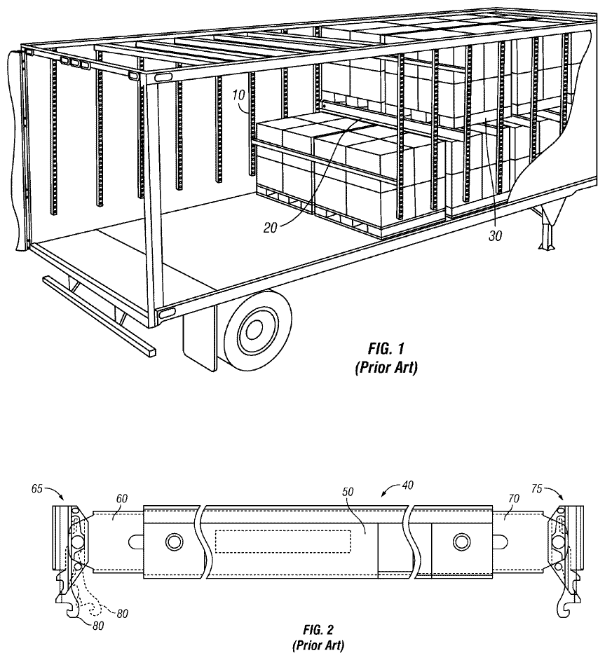

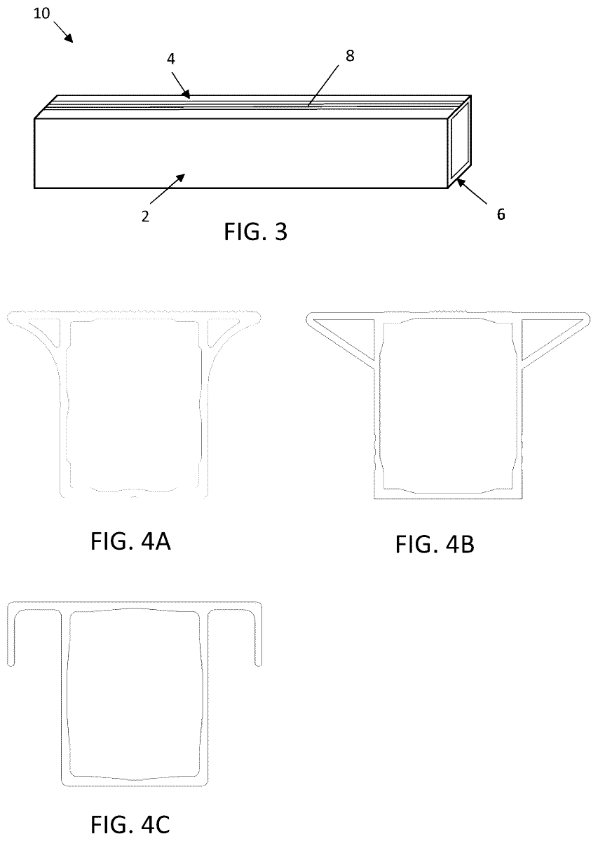

### DETAILED DESCRIPTION

The present disclosure describes aspects of the present invention with reference to the exemplary embodiments illustrated in the drawings; however, aspects of the present invention are not limited to the exemplary embodiments illustrated in the drawings. It will be apparent to those of ordinary skill in the art that aspects of the present invention include many more embodiments. Accordingly, aspects of the present invention are not to be restricted in light of the exemplary embodiments illustrated in the drawings. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

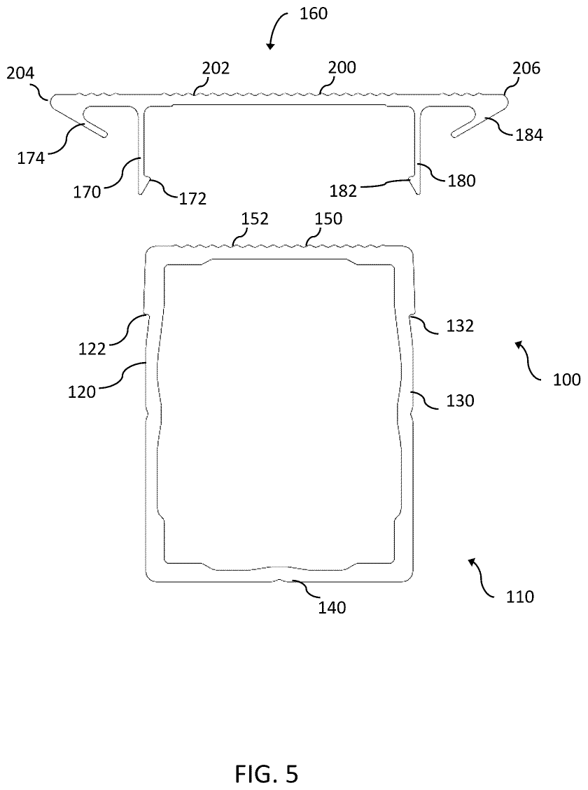

Referring now to FIG. 5-7, a cross-sectional view of the modular wide top beam extension system 100 is illustrated in detail. The system comprises two main components: a base beam 110 and a modular top section 160.

The base beam 110 features a rectangular (but not limited to) cross-section defined by a top wall 150, a bottom wall 140, a left side wall 120, and a right side wall 130. Each of these walls has an outside surface and an inside surface, with the inside surfaces forming a channel that extends along the longitudinal axis of the beam 110. The top wall 150 and bottom wall 140 are substantially parallel to each other, while the left side wall 120 and right side wall 130 are also substantially parallel to each other and perpendicular to the top and bottom walls.

In the embodiment disclosed in FIG. 5, the beam 110 has notches 122 and 132 on the outside surfaces of the left side wall 120 and right side wall 130, respectively. These notches 122, 132 are positioned below the upper corners of the beam, where the side walls meet the top wall. The notches 122 and 132 are designed to engage with the modular top section 160, providing a secure attachment mechanism.

It will be understood by a person of ordinary skill in the art that the notches 122 and 132 are not required for the operation of the modular wide top beam extension system. The modular top section 160 may be received, secured, or fastened to the base beam 110 through alternative configurations, including but not limited to adhesive bonding, mechanical fasteners, snap-fit or interlocking geometries, or frictional engagement with complementary surfaces. The particular attachment configuration illustrated in FIG. 5 is provided for illustrative purposes only, and variations that achieve equivalent engagement and securement between the base beam and the modular section fall within the scope of the invention.

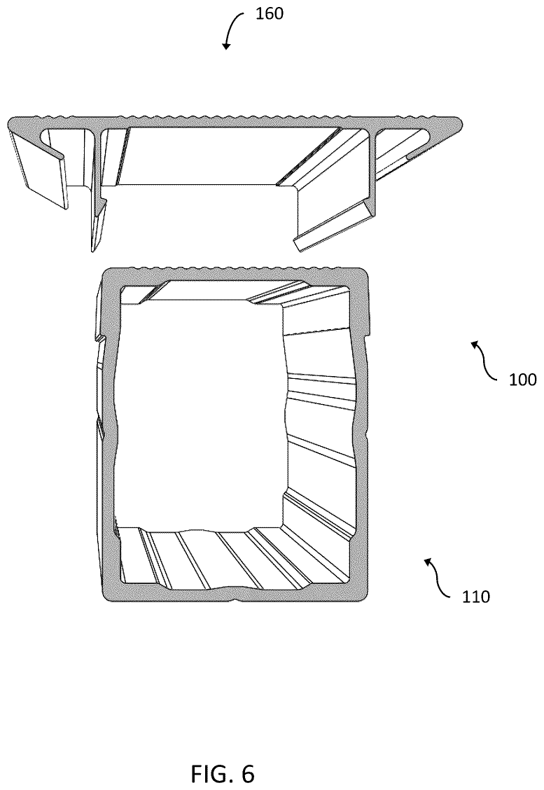

In reference to FIGS. 5 and 6, the notch is defined by an angular deviation in the outer surface of the left side 120 and the right side 130. In the embodiment shown, the notch extends along the length of the beam 110 from the first end to the second end and being parallel to the axis.

The modular top section 160 transforms the standard beam into a wide-top configuration. It features a substantially flat top surface 200 that extends significantly beyond the width of the base beam 110 on both the left and right sides. This extended width increases the load-bearing surface area, thereby improving load distribution and reducing the risk of cargo damage.

The modular top section 160 includes vertically descending sections 170 and 180 on its left and right sides, respectively. These descending sections are positioned at the outer edges of the extended top surface and run parallel to the side walls of the base beam. In the embodiment disclosed, the descending sections 170 and 180 terminate in inwardly protruding clips 172 and 182, respectively.

The clips 172 and 182 are specifically shaped to engage with the notches 122 and 132 on the base beam. Each clip has a hook-like geometry, with an upper surface that slopes inward and downward, leading to a sharp corner that fits into the corresponding notch. Below this corner, the clip extends slightly outward, creating a secure grip when engaged with the notch.

The engagement between the clips (172, 182) and the notches (122, 132) retains the modular top section 160 to the base beam 110. As the clips slide over the upper corners of the base beam, they flex slightly outward. Once the corners of the clips align with the notches, the clips snap into place, creating a firm, semi-permanent connection.

It will be understood by a person of skill in the art and familiar with this disclosure that in certain embodiments, the clip-and-notch engagement mechanism described above is not required. The descending sections 170 and 180 of the modular top section 160 may extend substantially straight downward from the top surface 200 without inwardly projecting clips. In such configurations, the modular top section 160 may rest directly upon the upper surface of the beam 110 and remain in position through gravity, frictional engagement, or an interference fit between the inner surfaces of the descending sections and the outer surfaces of the beam's side walls. This arrangement provides a simplified construction that still permits stable placement and easy removal of the modular section while eliminating the need for any mechanical interlock or specialized notch geometry.

The top section defines a top surface 200 that extends from a first end 204 to a second end 206. In the embodiment disclosed, the main body of the top section 200, which forms the extended load-bearing surface, has a generally trapezoidal cross-section. In the embodiment disclosed, the first end and the second end 204, 206 include extensions 174, 184 descending therefrom. In the embodiment disclosed, these extensions have both a downward component and an inward component. The extensions serve to increase the robustness of the first and second ends 204, 206 of the top surface. This is helpful from inhibiting unwanted part deformation caused by inadvertent positioning of cargo during the loading process.

In some embodiments of the present invention, the top surface 200 of the modular section is not completely flat but includes subtle contours. There are slight depressions or channels 202 running along the length of the top surface, near the outer edges. These channels can serve to guide cargo placement, increase friction, or channel away any liquids that might accumulate on the surface.

The interface between the modular top section 160 and the base beam 110 is designed for a close, secure fit. The bottom surface of the modular top section, where it meets the top wall 120 of the base beam, includes a slight recess or channel. This recess accommodates any surface irregularities on the top of the base beam and ensures a snug fit.

In terms of relative proportions, the width of the top surface 200 of the modular section is approximately twice that of the base beam 110. The height of the descending sections 170 and 180 is roughly one-third the height of the base beam's side walls. It will be understood by a person of skill in the art and familiar with this invention that this may vary. These proportions provide a significant increase in load-bearing surface area while maintaining a profile that doesn't excessively interfere with cargo loading and unloading. It will be understood by a person or ordinary skill in the art and familiar with this invention the geometry may vary.

This detailed geometry of the modular wide top beam extension system 100 ensures a secure, functional, and versatile solution for expanding the capabilities of standard cargo container decking beams. The precise interplay between the base beam 110 and the modular top section 160 allows for easy installation and removal while providing a stable and reliable wide-top beam configuration when assembled.

FIG. 6 provides a perspective view of the assembled modular wide top beam extension system 100. This view illustrates how the modular top section integrates with the base beam to create a wider, more robust decking solution.

In one embodiment, removal of the modular top section 160 from the base beam 110 may be accomplished by applying an upward and outward force along one or both of the descending sections 170 and 180 to disengage the clips 172 and 182 from the corresponding notches 122 and 132. In embodiments in which the descending sections are formed of a resilient material, the sections may elastically deflect outward during removal, permitting the clips to clear the upper corners of the base beam. Once disengaged, the modular top section 160 may be lifted vertically from the base beam 110. In other embodiments in which the modular section is retained by gravity, friction, or an interference fit, the modular section may be separated from the beam by lifting or sliding it upwardly relative to the base beam. These configurations allow for convenient removal and replacement of the modular sections without the need for tools or permanent fasteners.

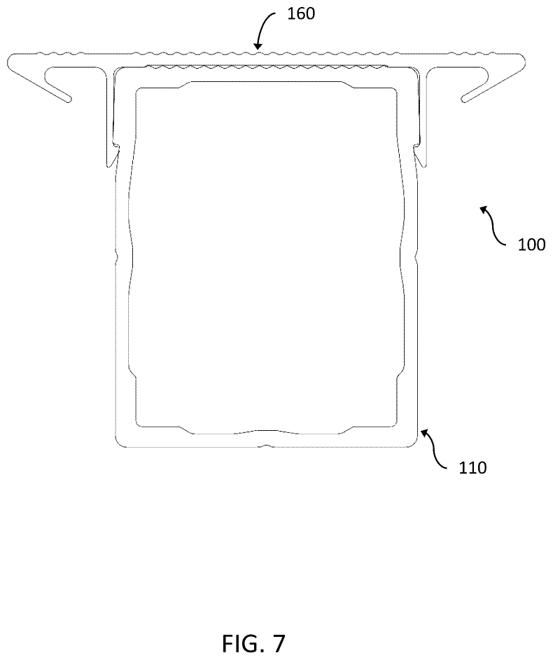

FIG. 7 presents another cross-sectional view of the system 100, illustrating the secure connection between the modular top section and the base beam. This figure highlights how the clips 172 and 182 engage with the notches 122 and 132, ensuring a stable and reliable wide-top beam configuration.

The modular nature of this system allows for various implementation options. The top section can be manufactured as a single piece covering the entire length of the beam, or it can be produced in smaller sections that can be interlocked or bonded together. This flexibility allows users to customize the system to their specific needs, including the option to extend only one side of the beam if desired.

The choice of materials for both the base beam and the modular top section can vary based on application requirements. While extruded aluminum is a preferred material due to its strength-to-weight ratio and corrosion resistance, the system's design principles can be applied to other materials such as steel, various plastics, or advanced composites. This material flexibility ensures that the system can be adapted to a wide range of cargo transportation scenarios, from lightweight applications to heavy-duty industrial use.

The attachment mechanism between the modular top section and the base beam is designed to provide a semi-permanent connection. The elastic properties of the clips allow for some flexing during installation, ensuring a snug fit while still allowing for removal when necessary. While the extended lips of the modular top section significantly increase the load-bearing surface area, it's important to note that these extensions are primarily designed for load distribution rather than direct heavy loading.

The extrusion design of both the base beam and the modular top section has been optimized for manufacturing efficiency and cost-effectiveness. The open profile of the base beam allows for the use of a solid die in the extrusion process, which offers benefits in terms of production speed, die lifespan, and the ability to achieve thinner wall sections where appropriate.

While specific loading calculations and testing results are not provided in this description, it's understood that the system would need to meet relevant industry standards for cargo securement. In Europe, for example, such systems are typically tested according to the VDI 2700 standard for structural loading.

In conclusion, this modular wide top beam extension system represents a significant advancement in cargo container decking technology. By combining the strength and versatility of traditional decking beams with the adaptability and ease of maintenance of a modular design, this system offers a superior solution for the evolving needs of the freight transportation industry.

A top section that can be fastened to an existing beam profile, enabling the beam to expand into a wider top beam. This provides flexibility in both beam size and structural capabilities, while maintaining the option for the original beam profile to be used independently.

Ease of Replacement and Maintenance: The clip-on or fastened section can be easily replaced if damaged, minimizing downtime and repair costs. Bonding taped and mechanically fastened options are also available. A removable section facilitates easier maintenance compared to a permanently attached beam feature.

Material Flexibility: The “clip-on/fastened” section can be manufactured from either metal or plastic, offering options for various applications, including both lightweight and heavy-duty requirements.

Modular Construction: This can be a single piece covering the full length, or just one side if only one side is needed. Additionally, it can consist of several interlocking or bonded sections assembled together, and not just be made of one single piece

Reduced Inventory Costs: The underlying beam can be used independently as a standard beam profile. When both a standard beam and a wide-top beam are required, only the accessory (the clip-on/fastened top section) needs to be stocked, which is significantly less expensive than maintaining an inventory of complete wide-top beam assemblies.

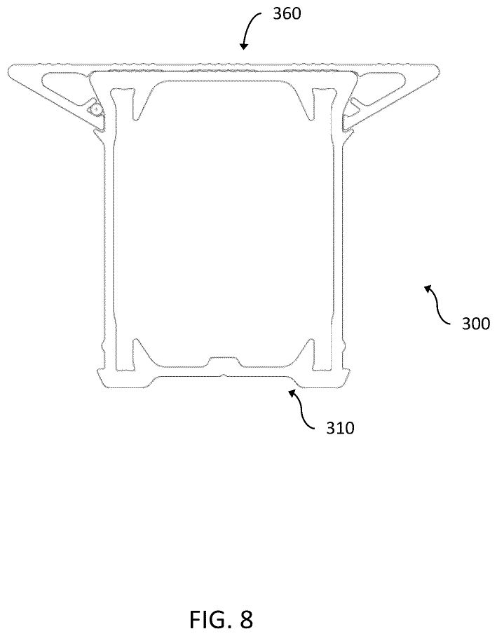

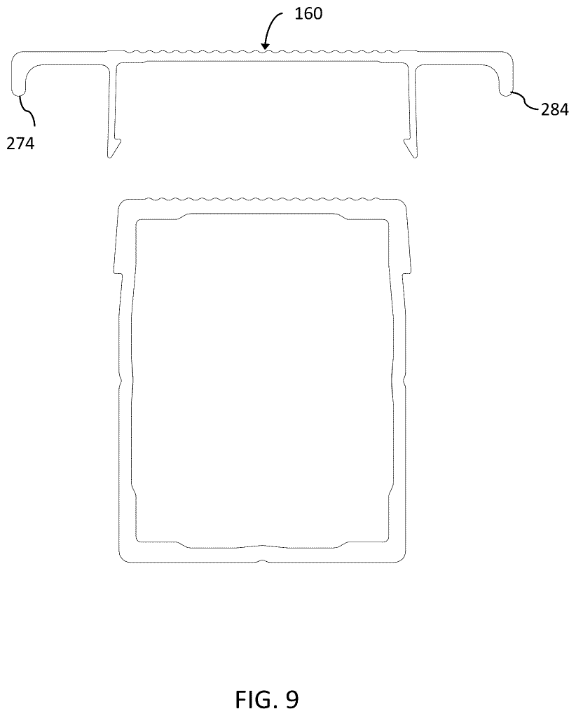

FIG. 8 illustrates an alternative embodiment 300 of the modular wide top beam extension system, presenting a novel approach to the concept that can be bonded, taped, or mechanically fastened into place. In this embodiment, the top section defines a top surface that extends from a first end to a second end. The first end and the second end include extensions descending therefrom. In the embodiment disclosed, these extensions have both a downward component and an inward component. The distal end of the extensions are configured to interface with the geometry of the sidewall to retain the modular top surface on the beam.

FIG. 9 illustrates an alternative embodiment of the modular top section 160 in which the descending extensions 274 and 284 extend substantially vertically downward from opposite ends of the top surface. A person of ordinary skill in the art and familiar with this invention will understand that different geometries are possible.

The present disclosure describes aspects of the invention with reference to the exemplary embodiments illustrated in the drawings; however, aspects of the invention are not limited to the exemplary embodiments illustrated in the drawings. It will be apparent to those of ordinary skill in the art that aspects of the invention include many more embodiments. Accordingly, aspects of the invention are not to be restricted in light of the exemplary embodiments illustrated in the drawings. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A modular wide top beam extension system for use in cargo containers, comprising:
a base beam extending along a longitudinal axis, the base beam having a top wall, a bottom wall, a left side wall, and a right side wall, each wall having an outside surface and an inside surface, the inside surfaces defining a channel extending along the longitudinal axis; and
a modular top section removably attachable to the base beam, the modular top section having a substantially flat top surface extending beyond the width of the base beam on both left and right sides, and further comprising vertically descending sections on the left and right sides.

2. The system of claim 1, wherein the outside surfaces of the left and right side walls each include at least one notch.

3. The system of claim 2, wherein each descending section includes a clip configured to engage with the notches on the base beam, thereby securing the modular top section to the base beam.

4. The system of claim 1, wherein the modular top section comprises multiple interlocking or bonded sections assembled together to cover the length of the base beam.

5. The system of claim 1, wherein the clips on the modular top section are designed to flex upon installation, providing elastic deformation for secure attachment to the base beam.

6. The system of claim 1, wherein the base beam is configured to function independently as a standard decking beam when the modular top section is not attached.

7. The system of claim 1, wherein the substantially flat top surface of the modular top section includes grooves extending along the longitudinal axis to increase friction with cargo.

8. The system of claim 1, wherein the modular top section includes hollow sections within its body, positioned above where it meets the base beam, to reduce weight and provide flexibility.

9. The system of claim 1, wherein the modular top section includes upward curves or lips or flat edges at the outer edges of its top surface to provide additional containment for cargo and structural rigidity.

10. The system of claim 1, wherein the bottom surface of the modular top section includes a recess or channel to accommodate surface irregularities on the top of the base beam and ensure a snug fit.

11. A method of expanding the load-bearing surface of a cargo container decking beam, comprising:
providing a base beam having a rectangular cross-section with notches on the outside surfaces of its left and right side walls;
providing a modular top section with a substantially flat top surface wider than the base beam and vertically descending sections terminating in clips;
aligning the modular top section with the base beam; and
engaging the clips of the modular top section with the notches on the base beam, thereby securely attaching the modular top section to the base beam and creating an expanded load-bearing surface.

12. The method of claim 11, further comprising selecting the material for the modular top section based on the specific load requirements of the intended application.

13. The method of claim 11, further comprising assembling multiple interlocking sections of the modular top section to cover the length or part the length of the base beam.

14. A cargo container decking system, comprising:
multiple base beams installed at adjustable heights within a cargo container; and
multiple modular top sections, each removably attachable to one of the base beams to create wide-top beams as needed, wherein each modular top section extends the width of its corresponding base beam and is secured to the base beam via a clip-and-notch mechanism.

15. The system of claim 14, wherein the modular top sections can be attached to either one or both sides of the base beams, allowing for asymmetric wide-top configurations.

16. A modular wide top beam extension system for use with a beam extending along a longitudinal axis, the beam having a top wall, a bottom wall, a left side wall, and a right side wall, each wall having an outside surface and an inside surface defining a channel extending along the longitudinal axis, the system comprising:
a modular top section removably receivable on the beam, the modular top section having a substantially flat top surface extending beyond the width of the beam on both left and right sides; and
vertically descending sections extending downward from the left and right sides of the top surface, each descending section configured to be received along an outside surface of the corresponding left or right side wall of the beam, thereby securing the modular top section to the beam.

17. The system of claim 16, wherein each descending section includes a clip portion positioned near a lower end thereof and configured to engage a corresponding notch formed on the outside surface of the beam.

18. The system of claim 17, wherein each clip portion extends inwardly toward the beam and includes an upper sloped surface and a lower corner configured to seat within the corresponding notch.

19. The system of claim 17, wherein the clips and notches are dimensioned to provide an elastic, snap-fit engagement between the modular top section and the beam.

20. The system of claim 17, wherein the notches extend along the length of the beam parallel to the longitudinal axis to receive the clips in continuous engagement along the beam's length.
